(19) United States
(12) Patent Application Publication
(10) Pub. No.: US 2025/0300935 A1
(43) Pub. Date: Sep. 25, 2025

(54) ELECTRONIC DEVICE FOR PERFORMING GRO BY USING ARTIFICIAL INTELLIGENCE MODEL AND OPERATING METHOD THEREOF

(71) Applicant: Samsung Electronics Co., Ltd., Suwon-si (KR)

(72) Inventors: Injae SONG, Suwon-si (KR); Dongho KIM, Suwon-si (KR); Kyunghoon LEE, Suwon-si (KR); Soomin LEE, Suwon-si (KR); Jusung LEE, Suwon-si (KR); Jongmin BAIK, Suwon-si (KR)

(21) Appl. No.: 19/232,253

(22) Filed: Jun. 9, 2025

Related U.S. Application Data
(63) Continuation of application No. PCT/KR2023/020244, filed on Dec. 8, 2023.

(30) Foreign Application Priority Data
Dec. 9, 2022 (KR) 10-2022-0171232
Dec. 23, 2022 (KR) 10-2022-0182673

(51) Int. Cl. H04L 47/193; H04L 47/2475

(52) U.S. Cl. CPC H04L 47/193; H04L 47/2475

(57) ABSTRACT

An electronic device is provided. The electronic device inlcudes memory storing instructions, at least one processor communicatively coupled to the memory, wherein the instructions, when executed by the at least one processor, cause the electronic device to identify at least one first application-association information corresponding to a first application, identify a first artificial intelligence (AI) model corresponding to the at least one first application association information from among the plurality of AI models, where each of the plurality of AI models is trained according to different compensation references for a training data set, identify a flush time for generic receive offload (GRO) by inputting information related to a communication environment of the electronic device into the first AI model, and perform a GRO operation for merging at least some of packets provided from a lower layer, based on the identified flush time for the GRO.

### CROSS-REFERENCE TO RELATED APPLICATION(S)

This application is a continuation application, claiming priority under 35 U.S.C. § 365(c), of an International application No. PCT/KR2023/020244, filed on Dec. 8, 2023, which is based on and claims the benefit of a Korean patent application number 10-2022-0171232, filed on Dec. 9, 2022, in the Korean Intellectual Property Office, and of a Korean patent application number 10-2022-0182673, filed on Dec. 23, 2022, in the Korean Intellectual Property Office, the disclosure of each of which is incorporated by reference herein in its entirety.

### BACKGROUND

### 1. Field

The disclosure relates to an electronic device performing generic receive offload (GRO) by using an artificial intelligence (AI) model and a method of operating the same.

### 2. Description of Related Art

GRO is a software-based offload transmission control protocol/Internet protocol (TCP/IP) communication technology used to reduce the overhead processed per data packet. For example, GRO may be used to reduce the overhead for high-speed network packet processing. For example, it is known that resources of 1 hertz (Hz) are required for processing 1 bis/s in TCP/IP. For example, network traffic at 5 giga bites (Gbit/s) (625 mega bites (MB/s)) may require central processing unit (CPU) processing at 5 giga hertz (GHz), and accordingly, two full cores of a 2.5 GHz multi-core processor may be needed to handle TCP/IP processing related to TCP/IP traffic at 5 Gbit/s.

Based on GRO, a network interface controller (NIC) layer may perform pre-processing of reassembling a data packet received by the network to a relatively larger data packet. Accordingly, a higher TCP layer may process a relatively smaller number of data packets, and thus the amount of work of merge of packets on the TCP layer may be reduced. For example, by GRO, the NIC layer may merge a plurality of received data packets into a data packet having the maximum size (for example, 64 KB) or smaller, based on an Internet protocol (IP) address, a port number, and/or a timestamp, and transfer the same a higher layer (for example, a TCP/IP layer (or kernel) and/or an application processor). Accordingly, resources and/or an amount of calculations required for a processing procedure of the higher layer may be reduced.

Based on GRO, at least some of the data packets received within a flush time from a time point at which a first received data packet is received (or is identified) may be merged and provided to the higher layer. For example, the flush time may be experimentally determined, and the electronic device may use a flush time of an optimized fixed value according to an experiment.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for performing GRO by using an AI model and a method of operating the same.

Additional aspects will be set forth in part in the description which follows and, in part, will be apparent from the description, or may be learned by practice of the presented embodiments.

In accordance with an aspect of the disclosure, an electronic device is provided. The electronic device includes memory, including one or more storage media, storing instructions and storing information associated with a plurality of applications and association information between a plurality of AI models, at least one processor communicatively coupled to the memory, wherein the instructions, when executed by at least one processor individually or collectively, cause the electronic device to identify at least one first application-associated information corresponding to a first application, identify a first AI model corresponding to the at least one first application-associated information from among the plurality of AI models by using the association information, each of the plurality of AI models being trained according to different compensation references for a training data set, identify a flush time for GRO by inputting information related to a communication environment of the electronic device into the first AI model, and perform a GRO operation for merging at least some of packets provided by a lower layer, based on the identified flush time for GRO.

In accordance with another aspect of the disclosure, a method of operating an electronic device is provided. The method includes identifying at least one first application-associated information corresponding to a first application, identifying a first AI model corresponding to the at least one first application-associated information among a plurality of AI models by using information associated with a plurality of applications and association information between the plurality of AI models, each of the plurality of AI models being trained according to different compensation references for a training data set, identifying a flush time for GRO by inputting information related to a communication environment of the electronic device into the first AI model, and performing a GRO operation for merging at least some of packets provided by a lower layer, based on the identified flush time for GRO.

In accordance with another aspect of the disclosure, one or more non-transitory computer-readable storage media storing one or more computer programs including computer-executable instruction that, when executed by the at least one processor of an electronic device individually or collectively, cause the electronic device to perform operations are provided. The operations include identifying at least one first application-associated information corresponding to a first application, identifying a first AI model corresponding to the at least one first application-associated information from among a plurality of AI models by using information associated with a plurality of applications and association information between the plurality of AI models, each of the plurality of AI models being trained according to different compensation references for a training data set, identifying a flush time for GRO by inputting information related to a communication environment of the electronic device into the first AI model, and performing a GRO operation for merging at least some of packets provided by a lower layer, based on the identified flush time for GRO.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2A is a diagram illustrating a performance of a GRO operation according to an embodiment of the disclosure;

FIG. 2B is a flowchart illustrating a method of operating an electronic device according to an embodiment of the disclosure;

FIGS. 2C and 2D are diagrams illustrating a size of packets over time according to various embodiments of the disclosure;

FIG. 3A is a flowchart illustrating a method of operating an electronic device according to an embodiment of the disclosure;

FIG. 3B is a diagram illustrating selection of an AI model according to an embodiment of the disclosure;

FIG. 4A is a flowchart illustrating a method of operating an electronic device according to an embodiment of the disclosure;

FIG. 4B is a diagram illustrating different AI models according to an embodiment of the disclosure;

FIGS. 4C, 4D, and 4E are diagrams illustrating an NN of an AI model according to various embodiments of the disclosure;

FIG. 5 is a flowchart illustrating a method of operating an electronic device according to an embodiment of the disclosure;

FIG. 6A is a flowchart illustrating a method of operating an electronic device according to an embodiment of the disclosure;

FIG. 6B is a flowchart illustrating a method of operating an electronic device according to an embodiment of the disclosure;

FIG. 6C is a diagram illustrating output values of a classification type AI model according to an embodiment of the disclosure;

FIG. 6D is a flowchart illustrating a method of operating an electronic device according to an embodiment of the disclosure;

FIG. 7 is a diagram illustrating an operation of identifying an AI model and a flush time for GRO according to an embodiment of the disclosure;

FIG. 8A is a flowchart illustrating a method operating a reinforcement learning (RL) agent according to an embodiment of the disclosure;

FIG. 8B is a diagram illustrating a RL agent and an application system according to an embodiment of the disclosure;

FIG. 8C is a diagram illustrating collection of training data and training and application of an AI model according to an embodiment of the disclosure;

FIGS. 9A, 9B, 9C, and 9D are graphs illustrating a relationship between a flush time and a throughput (TP) for each round trip time (RTT) according to various embodiments of the disclosure;

FIG. 10A is a flowchart illustrating a method of operating an electronic device according to an embodiment of the disclosure;

FIG. 10B is a diagram illustrating distribution of TPs according to an embodiment of the disclosure;

FIG. 10C is a diagram illustrating interquartile range (IQR) according to an embodiment of the disclosure;

FIG. 10D is a diagram illustrating IQR for each flush time according to an embodiment of the disclosure;

FIG. 10E illustrates TPs for each flush time of actually measured GRO according to an embodiment of the disclosure; and

FIG. 11 is a diagram illustrating comparison between TPs when a default flush time is used and TPs when a selected AI model is used according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

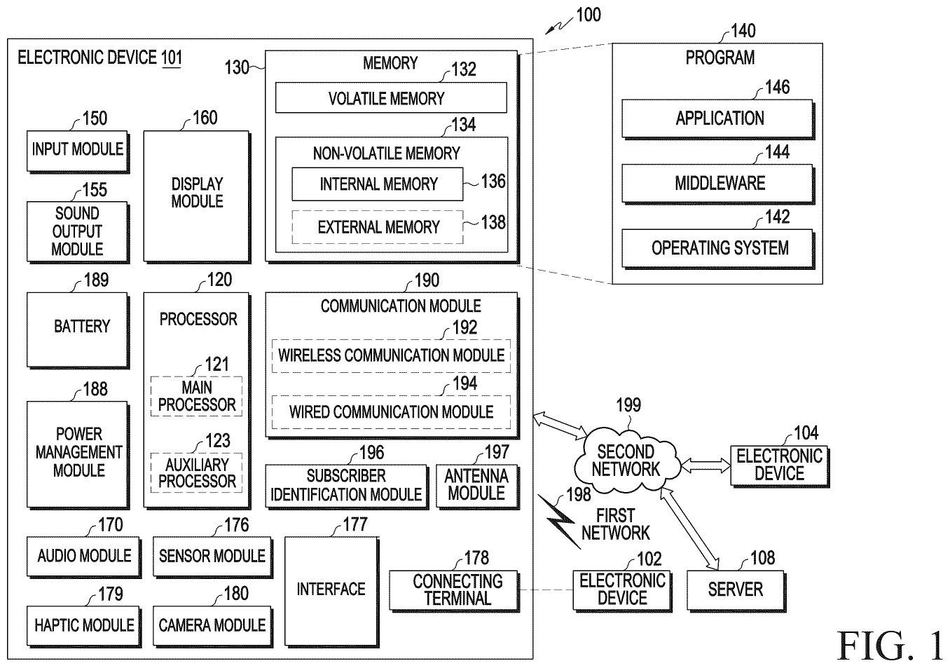

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 1or 04, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

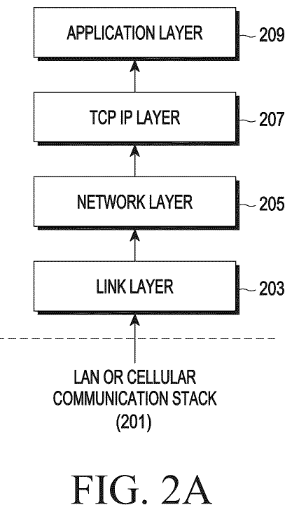

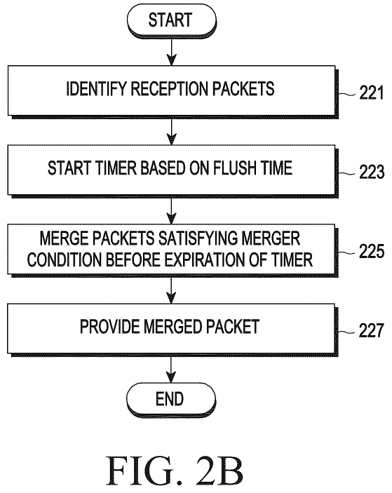

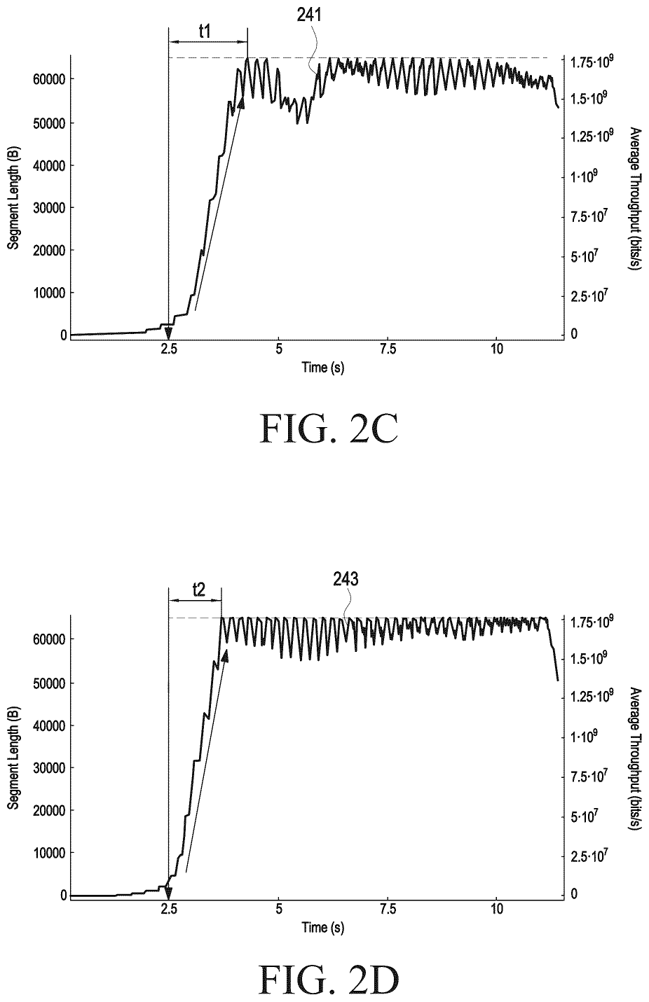

FIG. 2A is a diagram illustrating a performance of a GRO operation according to an embodiment of the disclosure.

Referring to FIG. 2A, according to an embodiment of the disclosure, a data packet may be provided from a LAN card or cellular communication stack 201. For example, when the electronic device 101 is wiredly connected to the network, the LAN card may provide a data packet based on a communication signal received from the outside. For example, when the electronic device 101 is wirelessly connected to the network, a communication processor (or modem) supporting the cellular communication stack may provide a data packet based on a received communication signal.

A link layer 203 may be defined as, for example, a network interface controller (NIC) layer but is not limited thereto. The NIC layer may include a NIC driver and/or hardware but is not limited thereto, and may be implemented in software, in which case the GRO operation may be performed by the processor 120 (for example, the application processor and/or the communication processor). It can be understood by those skilled in the art that the operation performed by the link layer 203 in the disclosure may be performed by the processor 120 (for example, the application processor and/or the communication processor). For example, the NIC layer may perform at least one operation for merging data packets and transmit the data packet as a data bitstream (for example, expressed by 0 or 1) to the network. The NIC layer may encode and compress data and determine a transmission rate of the network, a frame type and size, a timeout parameter, and/or a parameter including a buffer size. The link layer 203 may perform the GRO operation. The link layer 203 may receive a data packet from the LAN card or cellular communication stack 201. Based on the data packet being received, the link layer 203 may start a timer having an expiration time configured as a flush time. A plurality of data packets may be provided to the link layer 203 before expiration of the timer. The link layer 203 may merge data packets that satisfies a merger condition among the plurality of data packets received before expiration of the timer (or before the flush time passes). The link layer 203 may provide the merged data packet to a network layer 205. For example, the link layer 203 may provide (or push) the merged data packet, based on expiration of the timer (or elapse of the flush time, which may be called a GRO timeout). Alternatively, for example, the link layer 203 may provide the merged data packet, based on the size of the merged data packet reaching the maximum size (for example, 64 KB). The network layer 205 may process the received data packet and provide the same to a TCP/IP layer 207. The TCP/IP layer 207 may process the received data packet and provide the same to an application layer 209. For example, the network layer 205 and/or the TCP/IP layer 207 may be defined in a kernel space (or an operating system (OS) space) but is not limited thereto. The application layer 209 may be defined in, for example, a user space, but is not limited thereto. For example, the application layer 209, the TCP/IP layer 207, the network layer 205, and the link layer 203 may be defined and/or executed by the application processor but is not limited thereto.

Meanwhile, the flush time for the GRO operation may be determined by the electronic device 101. For example, the flush time may be determined based on an AI model. The AI model has information related to a communication environment as an input value and output the flush time. The AI model may be trained to acquire relatively high throughput (TP). For example, the electronic device 101 may select the AI model, based on application-associated information and identify the flush time by inputting the information related to the communication environment into the selected AI model, which will be described below.

FIG. 2B is a flowchart illustrating a method of operating an electronic device according to an embodiment of the disclosure.

Referring to FIG. 2B, in an embodiment of the disclosure, the electronic device 101 (for example, the processor 120) may identify reception packets in operation 221. The electronic device 101 may start a timer based on a flush time, based on the reception packets being identified, in operation 223. The time may have, for example, the flush time as an expiration time. For example, the electronic device 101 may determine the flush time, based on an AI model. For example, the electronic device 101 may input communication environment-related information into the AI model and identify the flush time output from the AI model. The electronic device 101 may select the AI model, based on application-associated information. The electronic device 101 may store a plurality of AI models (or a combination of parameters constituting the AI model) and select an AI model from among the plurality of AI models, based on the application-associated information. The electronic device 101 may merge packets that satisfy a merger condition before expiration of the timer in operation 225. The electronic device 101 may provide the merged packet in operation 227. For example, a higher layer may process the merged packet, and the processed data may be provided to a corresponding application.

FIGS. 2C and 2D are diagrams illustrating a packet size over time according to various embodiments of the disclosure.

Referring to FIGS. 2C and 2D, according to an embodiment of the disclosure, the electronic device 101 may identify a variable flush time, based on the application-associated information and/or the communication environment-related information. According to different flush times (for example, 2 ms and 80 ms), data packet sizes 241 and 243 may have different times t1 and t2 to reach the maximum value (for example, 64 KB). Depending on the different flush times, TPs according to respective cases may be also different. Accordingly, the electronic device 101 may configure an optimal flush time corresponding to the application-associated information and/or the communication environment. The electronic device 101 may select the AI model, based on the application-associated information as described above. For example, when a first application is executed, the electronic device 101 may select a first AI model, based on first application-associated information. The electronic device 101 may input first information related to the communication environment into the first AI model and identify a first flush time corresponding thereto. According to the elapse of time, the communication environment-related information may be changed from the first information to second information. The electronic device 101 may input the second information identified according to the elapse of time into the first AI model and identify a second flush time corresponding thereto. As described above, even for one application, the electronic device 101 may use different flush time according to different communication environment-related information.

For example, when the first application is executed, the electronic device 101 may select the first AI model, based on the first application-associated information. The electronic device 101 may input first information related to the communication environment into the first AI model and identify a first flush time corresponding thereto. Alternatively, when a second application is executed, the electronic device 101 may select a second AI model, based on second application-associated information. The electronic device 101 may input first information related to the communication environment into the second AI model and identify a second flush time corresponding thereto. Even for information related to the same communication environment, a different flush time may be configured according to an executed application.

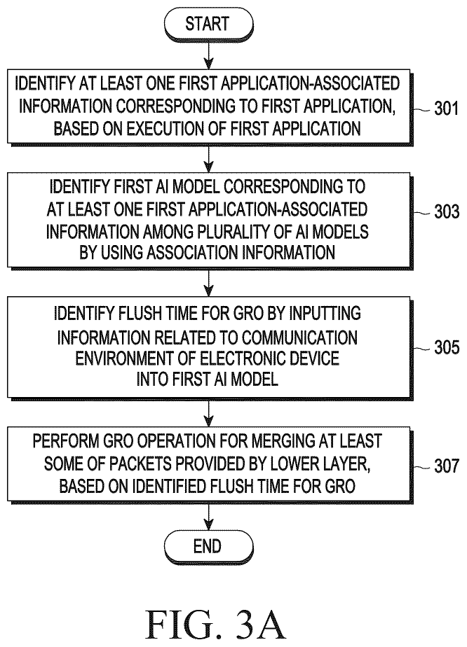

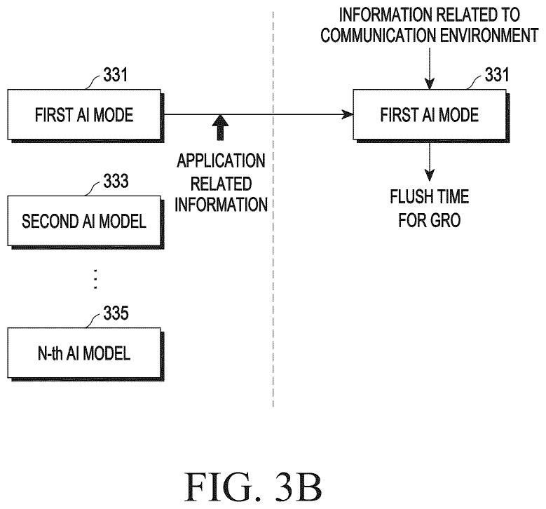

FIG. 3A is a flowchart illustrating a method of operating an electronic device according to an embodiment of the disclosure.

The embodiment of FIG. 3A will be described with reference to FIG. 3B.

FIG. 3B is a diagram illustrating selection of an AI model according to an embodiment of the disclosure.

Referring to FIGS. 3A and 3B, according to an embodiment of the disclosure, the electronic device 101 (for example, the processor 120) may identify information at least one first application-associated information corresponding to the first application, based on execution of the first application in operation 301. The electronic device 101 may identify a first AI model 331 corresponding to at least one first application-associated information among a plurality of AI models 331, 333, and 335 as illustrated in FIG. 3B by using related information in operation 303. Meanwhile, the electronic device 101 may store one AI model other than the plurality of AI models, and it is understood by those skilled in the art that selection of one AI model from among the plurality of AI models in embodiments of the disclosure may be replaced with selection (or identification) of one stored AI model. Meanwhile, in operation 301, execution of the first application is an example of triggers of the AI model selection. For example, the AI model corresponding to the first application may be selected based on download of the first application, installation of the first application, a request for the connection to the network from the first application, and/or establishment of a protocol data unit (PDU) session based on the first application.

In an embodiment of the disclosure, the plurality of AI models 331, 333, and 335 may be trained according to different compensation references for a training data set. For example, the first AI model 331 may be trained according to a compensation reference based on an intermediate value of the TP, the second AI model 333 may be trained according to a compensation reference based on a maximum value or a minimum value of the TP, and the third AI model 335 may be trained according to a value calculated based on at least one value identified based on TP distribution, but the value related to the compensation references are not limited thereto. Training of the AI models will be described below. For example, at least two models of the plurality of AI models 331, 333, and 335 may have, for example, the same neural networks (NNs), but at least some of the weight and/or bias corresponding to nodes of at least some of the NNs may be different. For example, at least two models of the plurality of AI models 331, 333, and 335 may have, for example, different NNs. For example, the number of input values and/or types of input value input into the NNs may be different, but there is no limitation.

For example, the application-associated information may include at least one piece of information for determining an application or an application type (or group). For example, the application-associated information may include an application ID. The application ID may include information, for example, android_tp, android_enterprise, and android_game but is not limited thereto, and it may be understood by those skilled in the art that an operating system in which the application ID is defined is also not limited to Android. For example, the application-associated information may include a DNN (or APN). The DNN may include, for example, INTERNET, IP multimedia subsystem (IMS), VIDEO, MAX_BANDWIDTH, and XBOX but is not limited thereto. For example, the application-associated information may include a resource type (for example, guaranteed bit rate (GBR) or non-GBR). For example, the application-associated information may include a 5QI value. For example, the application-associated information may include a service priority. For example, the application-associated information may include a delay reflecting tolerance (tolerable delay). For example, the application-associated information may include a traffic descriptor and/or a rout descriptor included in a (user equipment (UE) route selection policy (URSP)) rule corresponding to the application. For example, the application-associated information may include a fully qualified domain name (FQDN). For example, the application-associated information may include a destination Internet protocol (IP) address. For example, the application-associated information may include predetermined group information (or service type information). The group information (or service type information) may be information distinguished according to, for example, characteristics of traffic required by the application (for example, discrete high-capacity traffic, continuous high-capacity traffic, universal traffic, low-capacity traffic, or low-latency traffic but there is no limitation) but is not limited thereto.

In operation 305, according to an embodiment of the disclosure, the electronic device 101 may identify the flush time for GRO output from the first AI model 331 by inputting communication environment-related information of the of the electronic device 101 into the identified (or selected) first AI model 331. The AI models 331, 333, and 335 may receive the communication environment-related information as an input value and have an NN to output the flush time for GRO, and there is no limitation on a NN type and/or the number of layers.

In operation 307, the electronic device 101 may perform the GRO operation for merging at least some of the packets provided by a lower layer, based on the identified flush time for GRO. As described above, the electronic device 101 may start a timer having an expiration time of the flush time, based on the received packets being identified. The electronic device 101 may perform the GRO operation of merging at least some of the packets received before expiration of the timer that satisfy the merger condition and transfer the same to a higher layer. According to the above description, a different AI model may be selected for each application, and the flush time for GRO may also be different. The AI model may be trained to have the optimal TP for each application, and thus an optimal flush time corresponding to the application may be provided. Further, according to the above description, even a different AI model may be selected for each communication environment even for one application, and thus the flush time for GRO may also be different. Since the AI model may be trained to have the optimal TP for each communication environment, the optimal flush time corresponding to the communication environment may be provided.

For example, the communication environment-related information may include information related to a channel environment (for example, reference signal received power (RSRP), reference signal received quality (RSRQ), block error rate (BLER), buffer state, channel quality index (CQI), downlink throughput (DL TP), uplink throughput (UL TP), received signal strength indicator (RSSI), and/or signal to interference-plus-noise ratio (SINR), but is not limited thereto). For example, the communication environment-related information may include information related to a communication delay with a server (for example, a destination IP address and/or a round trip time (RTT), but is not limited thereto). The RTT may be calculated based on, for example, an Ack packet for a synchronization packet or identified by reading a pre-stored RTT. The number of streams and/or IP address information of the server may be identified. For example, the communication environment-related information may include information related to a network environment (for example, activated radio access technology (RAT), a modulation and coding scheme (MCS), mobile satellite services (MSS), packet data convergence protocol (PDCP) T-ordering, and whether carrier aggregation (CA) is activated (or the number of activated carrier components (CCs)), the number of data streams, whether dual connectivity (DC) is activated, an operation band, an MIMO layer, and/or a bandwidth, but is not limited thereto). Meanwhile, in addition to the above-described parameters, additional metadata may be further used as input values of the AI model for each application characteristic. For example, for an AI model corresponding to an application for image transmission and reception, an image and/or information related to the image (for example, framerate, resolution, and/or bitrate, but not limited thereto) may be furthered used as input values of the AI model. For example, FQDN may also be used as the input value of the AI model and, may be trained such that the AI model corresponds to a specific server. For example, the server for access may be different depending on the purpose, such as large download, speed measurement, and video streaming, and FQDN may also be used as the input value of the AI model.

As described above description, the electronic device 101 may primarily select one of the plurality of AI models 331, 333, and 335 by using application-associated information and input communication environment-related information into the selected AI model, so as to identify the flush time for GRO. Meanwhile, in an embodiment of the disclosure, the electronic device 101 may have the application-associated information and the communication environment-related information as input values and store the AI model trained to output the flush time for GRO. The electronic device 101 may identify the output flush time by inputting the application-associated information and the communication environment-related information into the AI model.

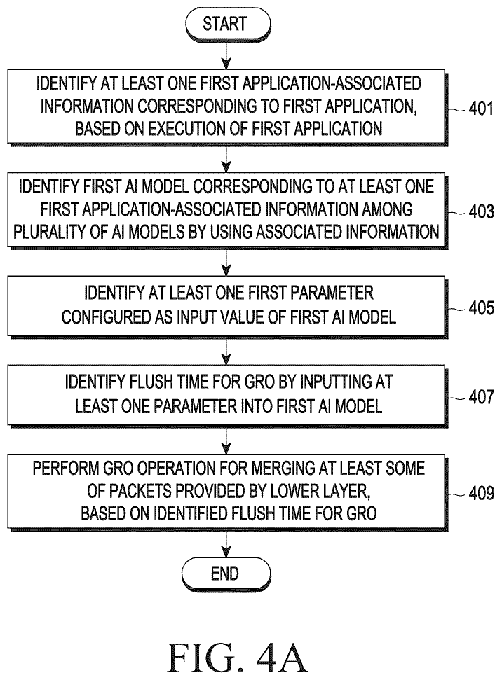

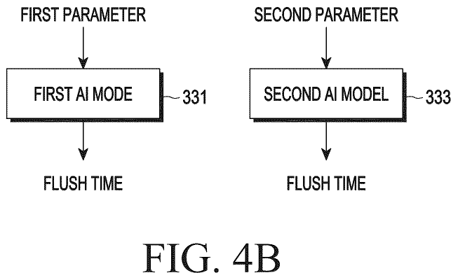

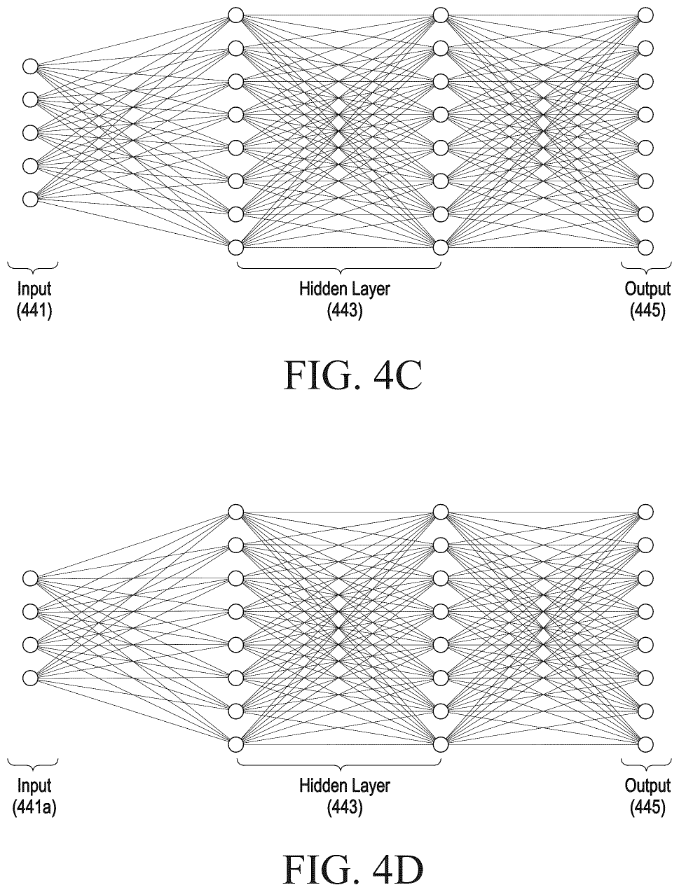

FIG. 4A is a flowchart illustrating a method of operating an electronic device according to an embodiment of the disclosure.

The embodiment of FIG. 4A is described with reference to FIGS. 4B to 4E.

FIG. 4B is a diagram illustrating different AI models according to an embodiment of the disclosure.

FIGS. 4C, 4D, and 4E are diagrams illustrating a NN of an AI model according to various embodiments of the disclosure.

Referring to FIGS. 4A, 4B, 4C, 4D, and 4E, according to an embodiment of the disclosure, the electronic device 101 (for example, the processor 120) may identify at least one first application-associated information corresponding to the first application, based on execution of the first application in operation 401. The electronic device 101 may identify the first AI model 331 corresponding to at least one first application-associated information among the plurality of AI models 331, 333, and 335 as illustrated in FIG. 3B by using related information in operation 403. The electronic device 101 may identify at least one first parameter configured as an input value of the first AI model 331 in operation 405. The electronic device 101 may identify a flush time for GRO by inputting at least one first parameter into the first AI model 331 in operation 407. Meanwhile, as illustrated in FIG. 4B, when the second AI model 333 is selected, at least one second parameter configured as an input value of the second AI model 333 may be input.

For example, at least one first parameter and at least one second parameter may be different from or the same as each other. For example, the first AI model 331 may have the NN illustrated in FIG. 4C. The NN of FIG. 4C may have an input layer (Input) 441, a hidden layer 443, and an output layer (Output) 445. The input layer (Input) 441 may have five nodes, and the five nodes may correspond to the RSRP, the RSRQ, the BLER, the buffer status, and the destination IP address, respectively. For example, the second AI model 333 may have the NN illustrated in FIG. 4D. The NN of FIG. 4D may have an input layer 441a, the hidden layer 443a, and the output layer 445. The input layer (Input) 441a may have four nodes, and the four nodes may correspond to the RSRP, the RSRQ, the BLER, and the buffer, respectively. As illustrated in the examples of FIGS. 4C and 4D, the first AI model 331 corresponds to, for example, a type for measurement of a communication speed of the electronic device 101, and it may be required to differently configure the flush time of GRO according to the destination IP address, and accordingly, the destination IP address may be configured as one of the input values of the first AI model 331. The second AI model 333 may correspond to, for example, a type of video streaming (for example, a service requiring discrete high-capacity TP). The number of IP addresses of a video streaming server may be plural and/or the influence of the IP addresses on the flush time may be relatively small. Accordingly, the input value of the second AI model 333 may not include the destination IP address. Meanwhile, as described above, the configuration of the parameter for the input for each AI model is only an example, and it can be understood by those skilled in the art that all of the AI models that can be selected by the electronic device 101 may have parameters for the same type input.

Meanwhile, the case in which AI models are the classification type has been described in FIGS. 4C and 4D, but is only an example. A plurality of nodes included in the output layer 445 of AI models of the classification type may correspond to different flush times (for example, 2 ms, 5 ms, 10 ms, 15 ms, 20 ms, 25 ms, 30 ms, and 35 ms but there is no limitation), and value of the nodes may probabilities (for example, values between 0 and 100% but there is no limitation) corresponding to the flush times. The electronic device 101 may determine a value corresponding to the highest probability as the flush time for GRO. The electronic device 101 may perform a verification operation on the identified value, which will be described below.

In an embodiment of the disclosure, the electronic device 101 may store and/or use the continuous type AI model illustrated in FIG. 4E. The NN of the AI model may include an input layer 451, a hidden layer 453, and an output layer 455. The output layer 455 may include, for example, two nodes. One of the two nodes may correspond to a value of the flush time, and the other one may be reliability of the value of the flush time (for example, a value between 0 and 100% but there is no limitation). For example, the electronic device 101 may identify that one of the nodes of the output layer 455 is 3 m and the other one is 70% and, accordingly, identify 3 ms as the flush time of reliability of 70%. The electronic device 101 may perform a verification operation on the identified value, which will be described below.

In operation 409, the electronic device 101 may perform the GRO operation for merging at least some of the packets provided by a lower layer, based on the identified flush time for GRO.

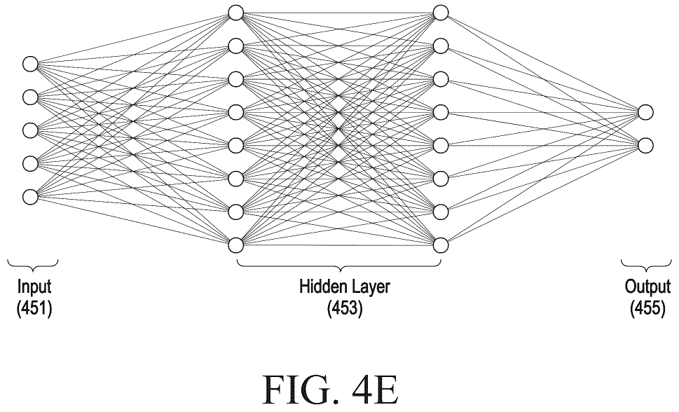

FIG. 5 is a flowchart illustrating a method of operating an electronic device according to an embodiment of the disclosure.

Referring to FIG. 5, according to an embodiment of the disclosure, the electronic device 101 (for example, the processor 120) may identify application-associated information in operation 501. The electronic device 101 may identify whether there is an AI model corresponding to the identified application-associated information in operation 503. For example, the electronic device 101 may store association information between the application-associated information and the AI model. Table 1 shows an example of the association information.

TABLE 1

| AI model | AppID | FQDN | Destination IP | DNN |
|---|---|---|---|---|
| First AI | android_tp | www.speed.org | None | Max_ |
| model | | | | bandwidth |
| Second AI | None | None | None | INTERNET |
| model | | | | |
| Third AI | android_ | www.fffchat.com | 10.30.281.* | VIDEO |
| model | enterprise | | | |
| Fourth AI | android_ | None | None | XBOX |
| model | game | | | |

Although it is shown in Table 1 that the application-associated information includes an AppID, an FQDN, a destination IP address, and a DNN, those skilled in the art may understood that they are only examples. The electronic device 101 may select an AI model corresponding to a first application as the first AI model by referencing the association information shown in Table 1, based on, for example, the AppID of the first application being “android_tp”. The electronic device 101 may select an AI model corresponding to the second application as the second AI model by referencing the association information shown in Table 1, based on, for example, the DNN of the second application being “INTERNET”.

When it is determined that there is the AI model corresponding to the identified application-associated information (503—Yes), the electronic device 101 may input information related to a communication environment into the corresponding AI model in operation 505. The electronic device 101 may identify the flush time output from the AI model in operation 507. When it is determined that there is no AI model corresponding to the identified application-associated information (503—No), the electronic device 101 may input information related to a communication environment into the default Ai model in operation 509. The electronic device 101 may identify the flush time output from the AI model in operation 511. Meanwhile, using the default AI model when there is no AI model corresponding to the identified application-associated information is only an example. In an embodiment of the disclosure, when there is no AI model corresponding to the identified application-associated information, the electronic device 101 may determine a default value (for example, 2 ms) as the flush time.

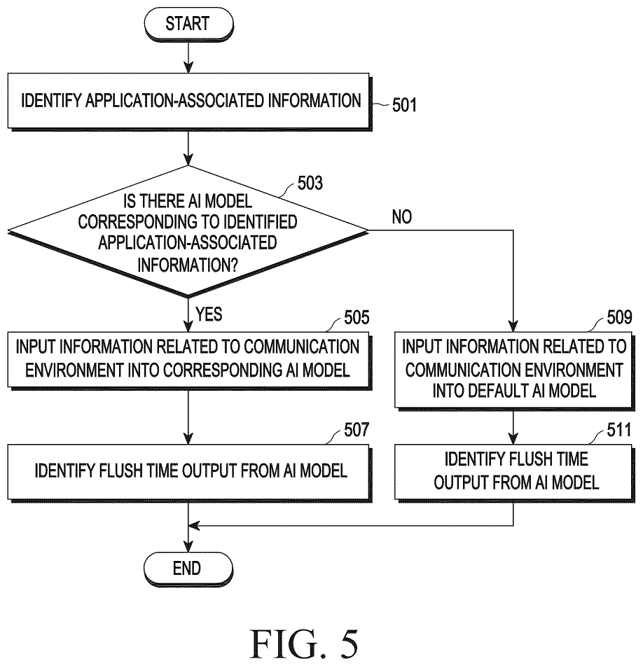

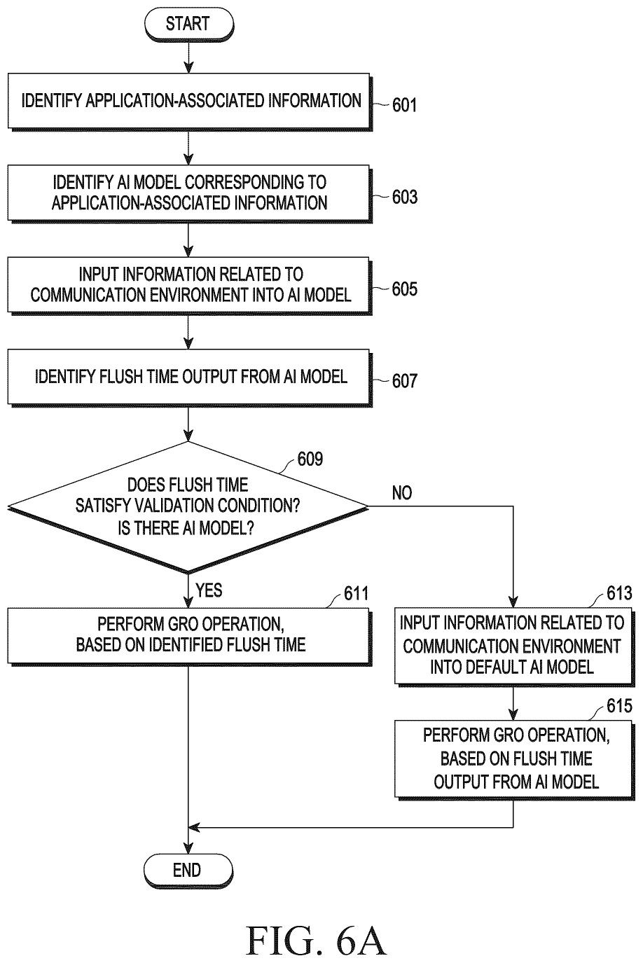

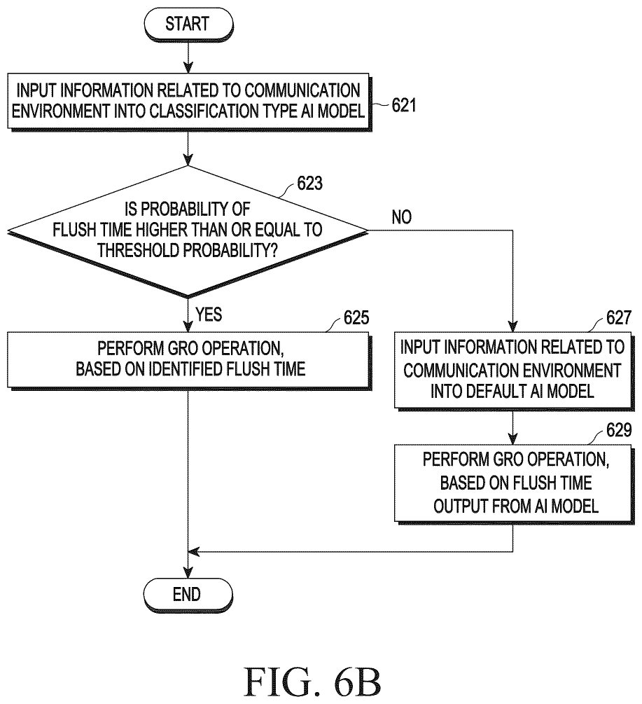

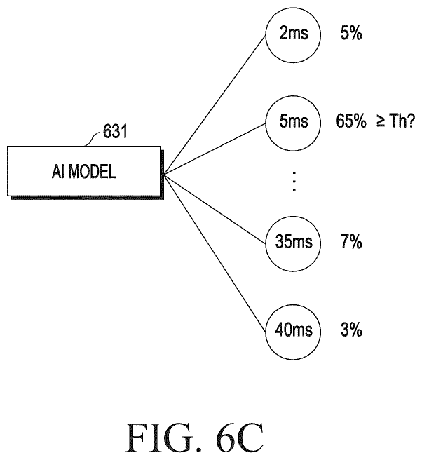

FIG. 6A is a flowchart illustrating a method of operating an electronic device according to an embodiment of the disclosure.

Referring to FIG. 6A, according to an embodiment of the disclosure, the electronic device 101 (for example, the processor 120) may identify application-associated information in operation 601. The electronic device 101 may identify an AI model corresponding to application-associated information in operation 603. The electronic device 101 may input information related to a communication environment into the AI model in operation 605. The electronic device 101 may identify the flush time output from the AI model in operation 607. The electronic device 101 may identify whether the flush time satisfies a validation condition in operation 609. When the value output from the AI model has relatively low reliability, it may be preferable to use another scheme (for example, an output value from a default AI model or a default value) rather than using the corresponding value. Accordingly, the electronic device 101 may identify whether the validation condition is satisfied to exclude the value having relatively low reliability. When it is identified that the flush time satisfies the validation condition (609—Yes), the electronic device 101 may perform a GRO operation, based on the identified flush time in operation 611. When it is identified that the flush time does not satisfy the validation condition (609—No), the electronic device 101 may input information related to the communication environment into the default AI model in operation 613. The electronic device 101 may perform the GRO operation, based on the flush time output from the default AI model in operation 615. Alternatively, as described above, when it is identified that the flush time does not satisfy the validation time (609—No), the electronic device 101 may perform the GRO operation, based on the default value (for example, 2 ms).

FIG. 6B is a flowchart illustrating a method of operating an electronic device according to an embodiment of the disclosure.

The embodiment of FIG. 6B is described with reference to FIG. 6C.

FIG. 6C is a diagram illustrating output values of a classification type AI model according to an embodiment of the disclosure.

Referring to FIGS. 6B and 6C, according to an embodiment of the disclosure, the electronic device 101 (for example, the processor 120) may input information related to a communication environment into, for example, the classification type AI model as illustrated in FIGS. 4C or 4D in operation 621. The electronic device 101 may identify the classification type AI model in accordance with application-associated information to be identified. The electronic device 101 may identify whether a probability of the flush time output from the classification type AI model is higher than or equal to a threshold probability (Th). For example, as described with reference to FIGS. 4C and 4D, the electronic device 101 may identify the probability for each flush time corresponding to the node of the output layer 445. Referring to FIG. 6B, an output layer of an AI model 631 may include a plurality of nodes, and respective nodes may correspond to flush times (for example, 2 ms, 5 ms, 35 ms, and 40 ms). The AI model 631 may provide probabilities corresponding to the flush times (for example, 2 ms, 5 ms, 35 ms, and 40 ms) as output values. The electronic device 101 may identify the flush time (for example, 5 ms) corresponding to the probability of the maximum value (for example, 65%) as the flush time for the GRO operation. The electronic device 101 may identify whether the identified probability (for example, 65%) is higher than or equal to the threshold probability. When the probability of the flush time is higher than or equal to the threshold probability (Th) (623—Yes), the electronic device 101 may perform the GRO operation, based on the identified flush time in operation 625. When the probability of the flush time is not higher than or equal to the threshold probability (Th) (623—No), the electronic device 101 may input information related to the communication environment into the default AI model in operation 627. The electronic device 101 may perform the GRO operation, based on the flush time output from the default AI model in operation 629. Alternatively, as described above, when the probability of the flush time is not higher than or equal to the threshold probability (Th) (623—No), the electronic device 101 may perform the GRO operation, based on the default value (for example, 2 ms).

FIG. 6D is a flowchart illustrating a method of operating an electronic device according to an embodiment of the disclosure.

Referring to FIG. 6D, according to an embodiment of the disclosure, the electronic device 101 (for example, the processor 120) may identify a first flush time by inputting the information related to the communication environment into, for example, the continuous type AI model illustrated in FIG. 4E in operation 641. The electronic device 101 may identify the continuous type AI model in accordance with the application-associated information to be identified. The electronic device 101 may identify a second flush time by inputting the information related to the communication environment into classification type AI model in operation 643. The first flush time and the second flush time may be different. The electronic device 101 may identify whether the first flush time and the second flush time satisfy a similarity association condition in operation 645. For example, the electronic device 101 may identify whether the difference between the first flush time and the second flush time is equal to or smaller than a threshold difference as the similarity association condition. When the similarity association condition is satisfied (645—Yes), the electronic device 101 may perform the GRO operation, based on the identified flush time in operation 647. When the similarity association condition is not satisfied (645—No), the electronic device 101 may identify a third flush time by inputting the information related to the communication environment into the default AI model in operation 649. The electronic device 101 may perform the GRO operation, based on the third flush time output from the default AI model in operation 651. Alternatively, as described above, when the similarity association condition is not satisfied (645—No), the electronic device 101 may perform the GRO operation, based on the default value (for example, 2 ms). Alternatively, in another example, the electronic device 101 may identify the flush time and reliability provided from the continuous type AI model. The electronic device 101 may identify whether to use the flush time or another value (for example, an output value form the default AI model or a default value), based on whether the reliability of the corresponding flush time is higher than or equal to threshold reliability.

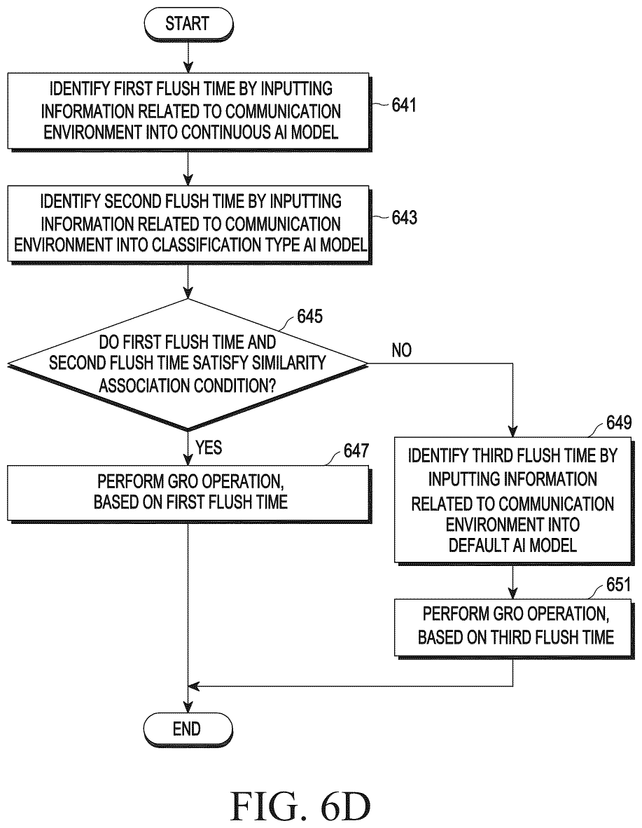

FIG. 7 is a diagram illustrating an operation of identifying an AI model and a flush time for GRO according to an embodiment of the disclosure.

Referring to FIG. 7, according to an embodiment of the disclosure, an application 701 may provide a network request to a platform 703 (for example, the TCP/IP layer 207 and/or the network layer 208 but there is no limitation) in operation 711. The network request may include application-associated information. The platform 703 may identify the application-associated information, based on the network request in operation 713. Alternatively, the application 701 may provide the application-associated information independently from the network request. Alternatively, the platform 703 may identify the application-associated information defined by (or stored in) another entity that is not from the application 701, or the platform 703, and there is no limitation in a method by which the platform 703 identifies the application-associated information. The platform 703 may identify an AI model corresponding to the application-associated information in operation 715. For example, the platform 703 may identify the AI model corresponding to the application-associated information by using the association information shown in Table 1. The platform 703 may provide information related to the identified AI model to a RIL/modem 705 (for example, the LAN card or cellular communication stack 201 and/or the link layer 203 but there is no limitation) in operation 717. Although it is described that the GRO operation is performed by the platform 703 in the embodiment of FIG. 7, it is only an example and there is no limitation in an entity performing the GRO operation, and the GRO operation may be performed by the RIL/modem 705.

According to an embodiment of the disclosure, the platform 703 may make a request for a setup data call to the RIL/modem 705, based on the network request in operation 719. The RIL/modem 705 may respond to the setup data call in operation 721. The RIL/modem 705 may perform, for example, at least one operation for PDU session establishment with the network, and a PDU session may be established. The RIL/modem 705 may provide the setup data call response to the platform 703. The platform 703 may provide a network callback to the application 701 in operation 723. In operation 725, a data session connection may be established. The application 701 may transmit and/or receive data to and/or from the network, based on the data session.

According to an embodiment of the disclosure, the RIL/modem 705 may identify information related to the communication environment in operation 727. The RIL/modem 705 may identify a flush time by inputting the information related to the communication environment into the AI model in operation 729. The RIL/modem 705 may identify validity of the flush time, as described with reference to, for example, FIGS. 6A to 6D, in operation 731. Based on the validity being identified, the RIL/modem 705 may provide the flush time to the platform 703 in operation 733. The platform 703 may perform the GRO operation, based on the flush time in operation 735. The platform 703 may receive a packet from the RIL/modem 705. Based on the packet being received, the platform 703 may start a timer having the flush time as an expiration time. The platform 703 may merge packets that satisfy a merger condition among a plurality of packets received before the time expires.

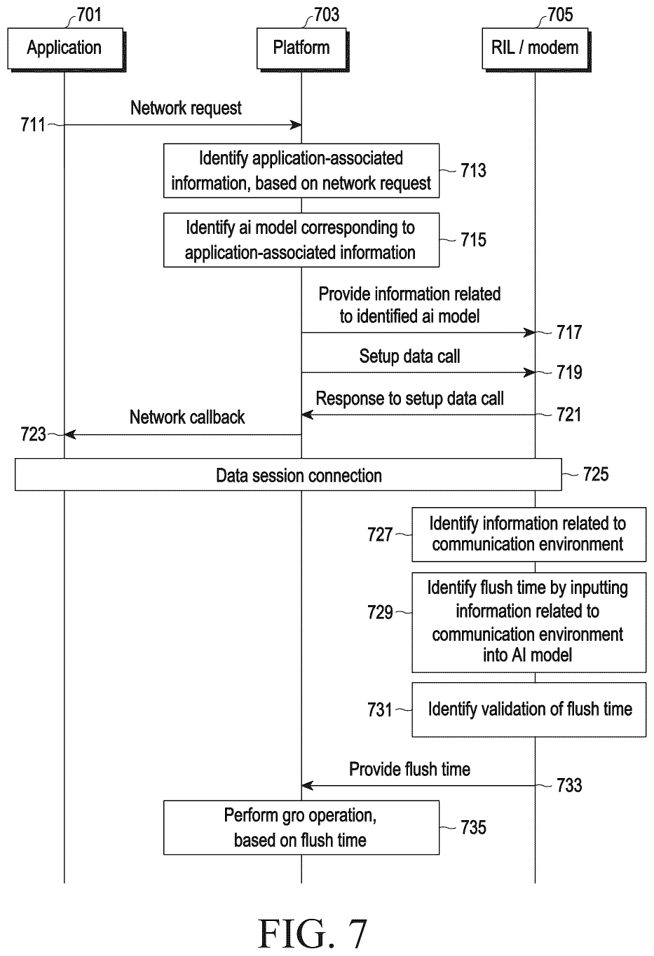

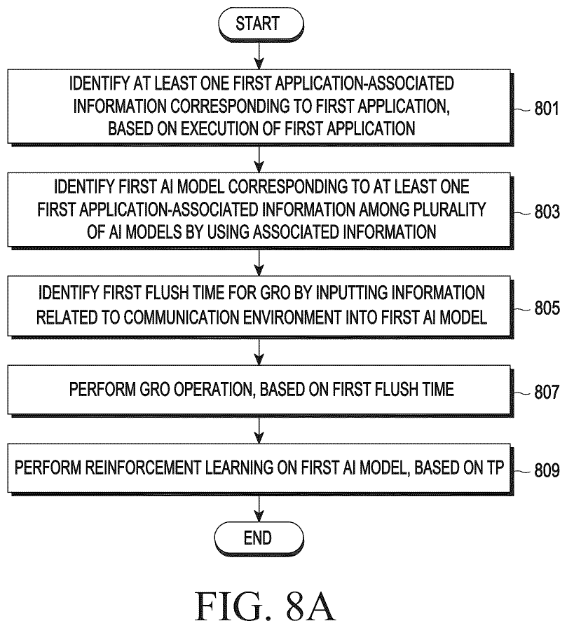

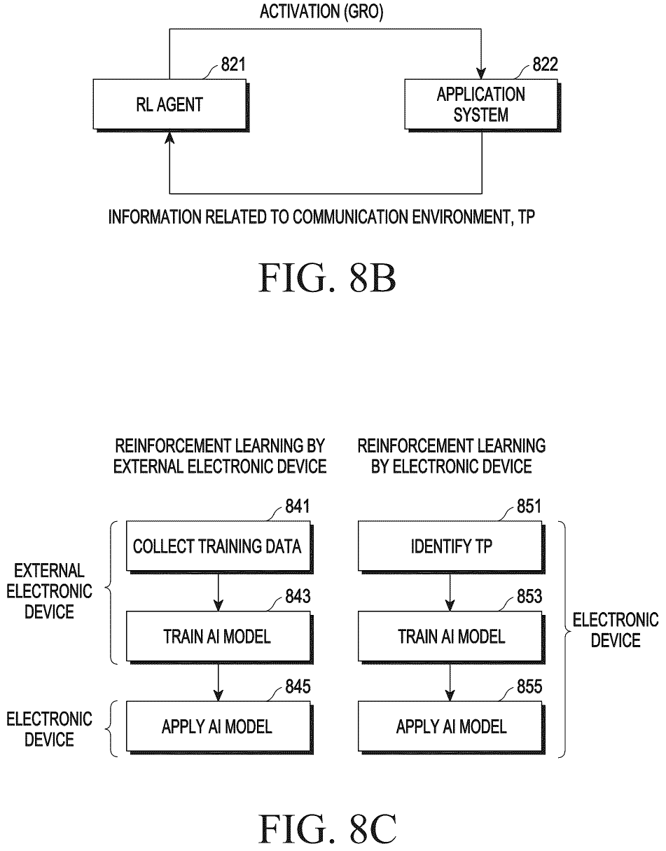

FIG. 8A is a flowchart illustrating a method operating a reinforcement learning (RL) agent according to an embodiment of the disclosure.

The embodiment of FIG. 8A is described with reference to FIGS. 8B and 8C.

FIG. 8B is a diagram illustrating a RL agent and an application system according to an embodiment of the disclosure.

FIG. 8C is a diagram illustrating collection of training data and training and application of an AI model according to an embodiment of the disclosure.

Referring to FIGS. 8A, 8B, and 8C, according to an embodiment of the disclosure, training of at least one AI model may be performed by the RL agent. Training may be performed by, for example, the server 108 (or another computing device) and/or performed by the electronic device 101 executing the AI model. It may be understood that the operation performed by the RL agent in the disclosure is performed by the electronic device 101 and/or the server 108.

Referring to both FIGS. 8A and 8B, according to an embodiment of the disclosure, the RL agent 821 may identify at least one first application-associated information corresponding to a first application, based on the first application being executed, in operation 801. The RL agent 821 may identify a first AI model corresponding to the at least one first application-associated information among a plurality of AI models by using the association information in operation 803. The RL agent 821 may identify a first flush time for GRO by inputting information related to the communication environment of the electronic device 101 into the first AI model in operation 805. The RL agent 821 may perform the GRO operation, based on the first flush time in operation 807. The RL agent may perform reinforcement learning on the first AI model, based on a TP identified during and/or after the GRO operation in operation 809. For example, the embodiments of FIGS. 8A and 8B may correspond to the case where TP identification 851, AI model training 853, and AI model application 855 are performed by the electronic device 101 like the embodiment on the right side of FIG. 8C. The RL agent 821 defined and/or executed by the electronic device 101 may receive information related to the communication environment and/or the TP from an application system 822 (for example, an entity capable of collecting the information related to the communication environment) and train the AI model, based on the received information. Meanwhile, performing all of the application and the training of the AI model by one entity (for example, the electronic device 101) is only an example, For example, referring to the embodiment on the left side of FIG. 8C, training data collection 841 and AI model training 843 may be performed by an external electronic device (for example, the server 108 but there is no limitation), and the AI model may be applied by the electronic device 101 as indicated by reference numeral 845. In this case, the external electronic device (for example, the server 108) may receive the information related to the communication environment and the TP from the electronic device 101 and perform reinforcement learning on the AI model, based on the received information. When a parameter of the AI model is changed according to the reinforcement learning, the external electronic device (for example, the server 108) may provide the changed parameter to the electronic device 101 applying the AI model.

Meanwhile, fluctuation of the measured TP may be large. For example, when a first action is performed in a first state, if the TP satisfies a compensation condition and thus the compensation is provided and then the first action is performed again in the first state, the TP may not satisfy the compensation condition. In this case, it may be difficult to determine whether reinforcement on the first action is needed. In order to train the AI model, based on the TP, it is required to provide as constant compensation as possible, and accordingly, an IQR technique may be used, which will be described below.

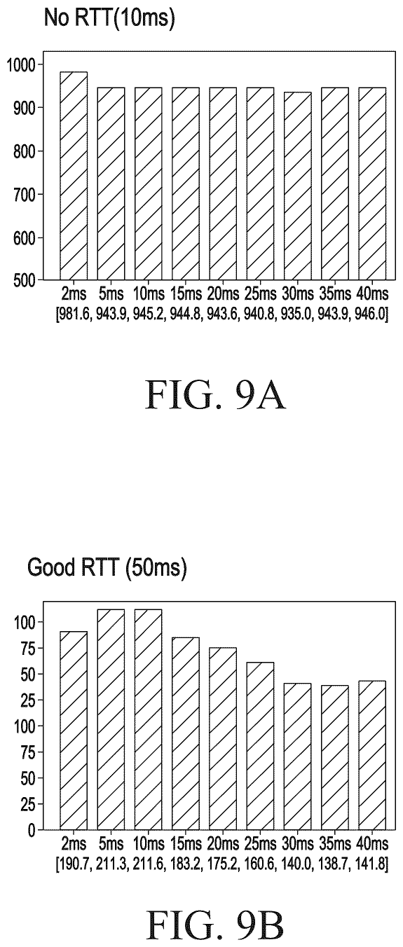

FIGS. 9A, 9B, 9C, and 9D are graphs illustrating a relationship between a flush time and a TP for each RTT according to various embodiments of the disclosure.

Referring to FIG. 9A, TPs are illustrated for respective flush times (2 ms, 5 ms, 10 ms, 15 ms, 20 ms, 25 ms, 30 ms, 35 ms, and 40 ms) for each GRO in the case where the RTT is 10 ms. The TPs may be similar for each flush time, but it may be identified that an optimal TP is measured at 2 ms.

Referring to FIG. 9B, TPs are illustrated for respective flush times (2 ms, 5 ms, 10 ms, 15 ms, 20 ms, 25 ms, 30 ms, 35 ms, and 40 ms) for each GRO in the case where the RTT is 50 ms. It may be identified that an optimal TP is measured at 5 ms or 10 ms.

Referring to FIG. 9C, TPs are illustrated for respective flush times (2 ms, 5 ms, 10 ms, 15 ms, 20 ms, 25 ms, 30 ms, 35 ms, and 40 ms) for each GRO in the case where the RTT is 100 ms. It may be identified that an optimal TP is measured at 10 ms.

Referring to FIG. 9D, TPs are illustrated for respective flush times (2 ms, 5 ms, 10 ms, 15 ms, 20 ms, 25 ms, 30 ms, 35 ms, and 40 ms) for each GRO in the case where the RTT is 200 ms. It may be identified that an optimal TP is measured at 5 ms. As described above, the flush time for the optimal TP may be different depending on information for a communication environment (for example, RTT). An AI model may be trained (for example, reinforcement learning) to provide the optimal TP according to information for the communication environment (for example, RTT).

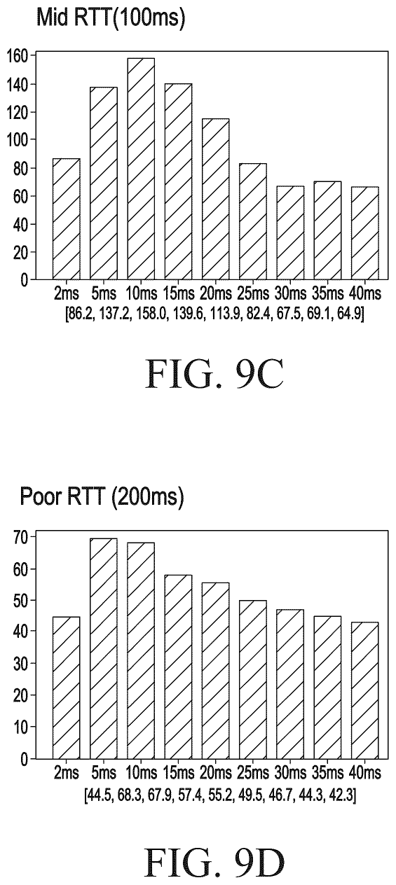

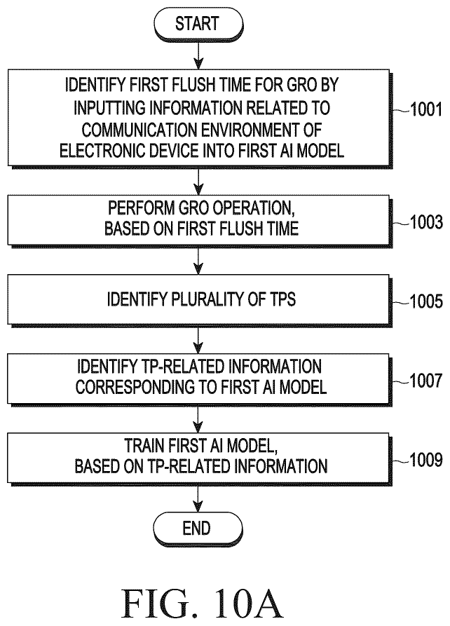

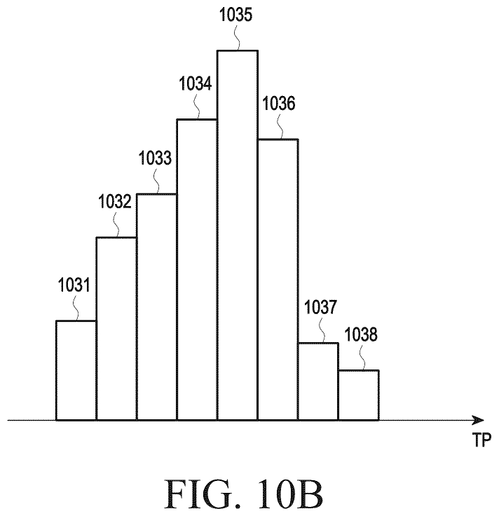

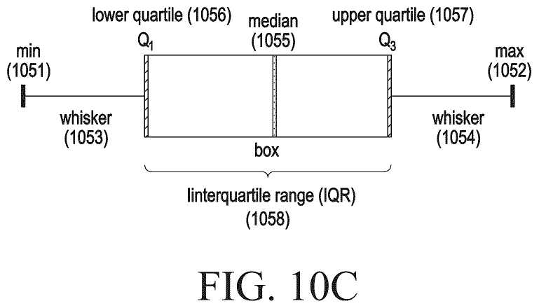

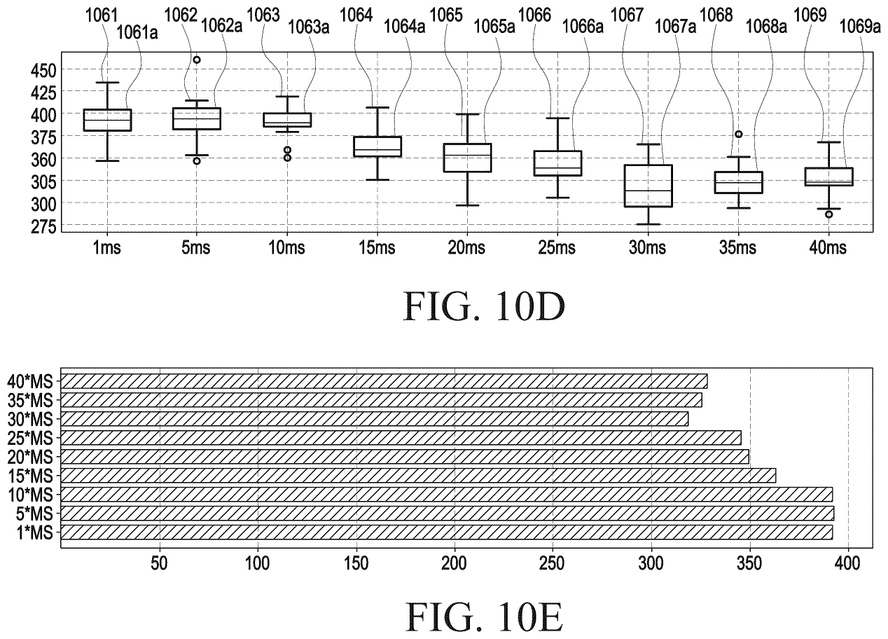

FIG. 10A is a flowchart illustrating a method of operating an electronic device according to an embodiment of the disclosure.

It can be understood by those skilled in the art that at least some of the method of operating the electronic device in FIG. 10A (for example, an operation for training) may be performed by the server 108 for training. The embodiment of FIG. 10A is described with reference to FIGS. 10B to 10E.

FIG. 10B is a diagram illustrating distribution of TPs according to an embodiment of the disclosure.

FIG. 10C is a diagram illustrating an IQR according to an embodiment of the disclosure.

FIG. 10D is a diagram illustrating an IQR for each flush time according to an embodiment of the disclosure.

FIG. 10E illustrates TPs for each flush time of actually measured GRO according to an embodiment of the disclosure.

Referring to FIG. 10A, the electronic device 101 may identify a first flush time for GRO by inputting information related to a communication environment of the electronic device into a first AI model in operation 1001. The electronic device 101 may perform a GRO operation, based on the first flush time in operation 1003. The electronic device 101 may identify a plurality of TPs in operation 1005. The electronic device 101 may identify TP-related information corresponding to the first AI model in operation 1007. The TP-related information may be configured based on at least some of the values identified based on, for example, a median, a maximum value, a minimum value, and/or the size of an IQR in TP distribution, but there is no limitation. The electronic device 101 may train the first AI model, based on the TP-related information in operation 1009.

Referring to FIG. 10B, for example, the distribution of TPs identified (or acquired) by the electronic device 101 (or an external electronic device for performing training) may have bins 1031, 1032, 1033, 1034, 1035, 1036, 1037, and 1038. Meanwhile, as described above, since fluctuation of TPs may be large, the application of a relatively regular compensation policy may be needed. Accordingly, the electronic device 101 may configure an interquartile range (IQR) 1058 for the TP.

Referring to FIG. 10C, for example, a median 1055 of the distribution may be configured. Further, a lower quartile value 1056 corresponding to the frequency of bottom 25% for the distribution illustrated in FIG. 10B and an upper quartile value 1057 corresponding to the frequency of top 25% may be configured. The length from the low quartile value 1056 to the upper quartile value 1057 may be configured as an IQR 1058. Meanwhile, a value from a minimum value 1051 to the lower quartile value 1056 is a whisker 1053 and may not be used for reinforcement learning. A value from the upper quartile value 1057 to a maximum value 1052 is a whisker 1054 and may not be used for reinforcement learning.

Referring to FIG. 10D, it illustrates IQRs 1061a, 1062a, 1063a, 1064a, 1065a, 1066a, 1067a, 1068a, and 1069a corresponding to the distribution of TPs measured for each flush time. Since calculation of the IQRs 1061a, 1062a, 1063a, 1064a, 1065a, 1066a, 1067a, 1068a, and 1069a has been described with reference to, for example, FIG. 10C, the detailed description thereof is not repeated. Meanwhile, the electronic device 101 may identify values 1061, 1062, 1063, 1064, 1065, 1066, 1067, 1068, and 1069 for training, based on the lengths of the IQRs 1061a, 1062a, 1063a, 1064a, 1065a, 1066a, 1067a, 1068a, and 1069a and the upper quartile value. The calculation of the training value may be performed based on, for example, Equation 1.

$$value for training = Q 3 + 1 \text{.4} \times IQR \qquad Equation l$$

In Equation 1, Q3 denotes an upper quartile value and IQR denotes the length of the IQR. Meanwhile, Equation 1 is only an example and there is no limitation in a method of obtaining the value for training. The value for training may be configured based on a relatively large upper quartile value and the length of the IQR indicating characteristics of distribution. For example, the median may be used as the compensation reference for the AI model, and the training value shown in Equation 1 may be used for the AI model corresponding to the purpose of measuring a TP speed.

Referring to FIG. 10E, it illustrates TPs for each flush time of actually measured GRO. The corresponding result is a result learned by, for example, the median as the compensation reference, in which the optimal flush time may be identified as 5 ms. Although not illustrated, in the result learned based on the value for training shown in Equation 1, the optimal flush time may be identified as 2 ms. As described above, different AI models may be identified based on various compensation references, and each of the different AI models may be stored and/or managed in accordance with application-associated information. For example, Table 2 shows the relationship between AI model-specific compensation reference and application characteristic information according to an embodiment.

TABLE 2

| | Application | | Compensation | use for |
|---|---|---|---|---|
| AI model | characteristic | Input value | reference | App |
| First AI | General | default | median TP | Internet |
| model | purpose | | | |
| Second AI | High | Default | Value for | TP |
| model | bandwidth | | training | measurement |
| | | | according | |
| | | | to Equation 1 | |
| Third AI | Video | Default + | median TP + | Video |
| model | | framerate/ | FER(frame | streaming |
| | | resolution | error rate) | |
| Fourth AI | Low latency | Default | Medial TP + | Game |
| model | | | average RTT | |

For example, the first AI model may correspond to application-associated information for Internet, and a TP median may be used and trained as the compensation reference. For example, the second AI model may correspond to application-associated information for TP measurement, and the value for training according to Equation 1 may be used and trained as the compensation reference. For example, the third AI model may correspond to application-associated information for video streaming, and the TP median and the FER may be used and trained as the compensation reference. Like the third AI model, not only a value related to TP distribution but also an additional parameter (for example, FER) may also be used as the compensation reference. Not only a default value (for example, information related to a communication environment) but also information related to an image (for example, a frame rate and resolution) may be additionally input into the third AI model. For example, the fourth AI model may correspond to application-associated information for a game, and the TP median and the average RTT may be used and trained as the compensation reference. Like the third AI model, not only a value related to TP distribution but also an additional parameter (for example, average RTT) may also be used as the compensation reference. Meanwhile, for the purpose of the GBR in addition to the examples of Table 2, a minimum value of TPs (or a relatively small value for training that reflects the length of IQR) may be used as the compensation reference.

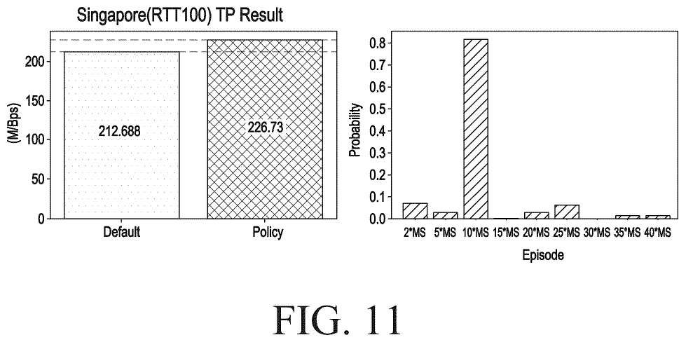

FIG. 11 is a diagram illustrating comparison between TPs when a default flush time is used and TPs when the selected AI model is used according to an embodiment of the disclosure.

Referring to FIG. 11, as the result of inputting information related to the communication environment into the classification type AP model, the optimal flush time may be provided as 10 ms. 226.73 TPs may be identified when 10 ms is applied as the flush time (policy), and 212,668 TPs may be identified when the default flush time (for example, 2 ms) is used. As described above, higher TPs may be identified when the default value is used compared to the case where the AI model is used.

According to an embodiment of the disclosure, an electronic device (for example, the electronic device 101 of FIG. 1) may include memory (for example, the memory 130 of FIG. 1) storing instructions and storing information associated with a plurality of applications and association information between a plurality of AI models. The electronic device 101 may include at least one processor (for example, the processor 120 of FIG. 1). The instructions may cause, when executed by the at least one processor 120, the electronic device 101 to identify at least one first application-associated information corresponding to a first application. The instructions may cause, when executed by the at least one processor 120, the electronic device 101 to identify a first AI model corresponding to the at least one first application-associated information among the plurality of AI models by using the association information. Each of the plurality of AI models may be trained according to different compensation references for a training data set. The instructions may cause, when executed by the at least one processor 120, the electronic device 101 to identify a flush time for GRO by inputting information related to a communication environment of the electronic device 101 into the first AI model. The instructions may cause, when executed by the at least one processor 120, the electronic device 101 to perform a GRO operation for merging at least some of packets provided by a lower layer, based on the identified flush time for GRO.

According to an embodiment of the disclosure, the instructions may cause, when executed by the at least one processor 120, the electronic device 101 to, as at least a portion of the operation of identifying the at least one first application-associated information corresponding to the first application, identify the at least one first application-associated information corresponding to the first application, based on execution of the first application, download of the first application, installation of the first application, a network connection request from the first application, and/or establishment of a PDU session corresponding to the first application.

According to an embodiment of the disclosure, the first application-associated information may include at least some of an application identifier (app ID), a DNN, a resource type, a 5QI value, a service priority, a delay, a traffic descriptor and/or route descriptor included in a URSP rule, an FQDN, a destination IP address, or group information.

According to an embodiment of the disclosure, the instructions may cause, when executed by the at least one processor 120, the electronic device 101 to, as at least a portion of the operation identifying the flush time by inputting the information related to the communication environment of the electronic device 101 into the first AI model, identify the flush time by at least one first parameter configured as an input value of the first AI model into the first AI model as the information related to the communication environment of the electronic device 101.

According to an embodiment of the disclosure, the instructions may cause, when executed by the at least one processor 120, the electronic device 101 to identify at least one second application-associated information corresponding to a second application different from the first application. The instructions may cause, when executed by the at least one processor 120, the electronic device 101 to, based on an AI model corresponding to the at least one second application-associated information, not existing by using the association information, identify the flush time for GRO by inputting the information related to the communication environment of the electronic device 101 into a default AI model or identify a default value as the flush time.

According to an embodiment of the disclosure, the information related to the communication environment may include at least one of information related to a channel environment, information related to a delay, or information related to a network environment. The information related to the channel environment may include at least one of an RSRP, an RSRQ, a BLER, a buffer status, a CQI, a DL TP, a UL TP, an RSSI, or an SINR. The information related to the network environment may include at least one of a destination IP address, a RTT, or an FQDN. The information related to the network environment may include at least one of an activated RAT, an MCS, an MSS, PDCP T-ordering, whether CA is activated, a number of activated CCs, a number of data streams, whether DC is activated, an operating band, an MIMO layer, or a bandwidth.

According to an embodiment of the disclosure, the instructions may cause, when executed by the at least one processor 120, the electronic device 101 to, as at least a portion of the operation of performing the GRO operation, based on the identified flush time for GRO, perform the GRO operation, based on a probability corresponding to the identified flush time for GRO, being higher than or equal to a threshold probability.

According to an embodiment of the disclosure, the instructions may cause, when executed by the at least one processor 120, the electronic device 101 to, as at least a portion of the operation of performing the GRO operation, based on the identified flush time for GRO, identify a flush time for comparison by inputting the information related to the communication environment of the electronic device 101 into a classification type AI model for comparison. The instructions may cause, when executed by the at least one processor 120, the electronic device 101 to, as at least a portion of the operation of performing the GRO operation, based on the identified flush time for GRO, perform the GRO operation, based on the flush time for comparison and the identified flush time for GRO satisfying a similarity association condition.

According to an embodiment of the disclosure, the instructions may cause, when executed by the at least one processor 120, the electronic device 101 to perform reinforcement learning on at least some of the plurality of AI models, based on an input value into at least some of the plurality of AI models, an output value from at least some of the plurality of AI models, and a value related to a TP associated with at least some of the plurality of AI models.

According to an embodiment of the disclosure, the first AI model in the plurality of AI models may be reinforcement-learned based on a compensation reference of a value identified based on a first processing scheme as a value related to the TP, and a second AI model different from the first AI model in the plurality of AI models may be reinforcement-learned based on a value identified based on a second processing scheme different from the first processing scheme as a value related to the TP.

According to an embodiment of the disclosure, a method of operating the electronic device 101 may include an operation of identifying at least one first application-associated information corresponding to a first application. The method of operating the electronic device 101 may include an operation of identifying a first AI model corresponding to the at least one first application-associated information among a plurality of AI models by using information associated with a plurality of applications and association information between the plurality of AI models. Each of the plurality of AI models may be trained according to different compensation references for a training data set;. The method of operating the electronic device 101 may include an operation of identifying a flush time for GRO by inputting information related to a communication environment of the electronic device 101 into the first AI model. The method of operating the electronic device 101 may include an operation of performing a GRO operation for merging at least some of packets provided by a lower layer, based on the identified flush time for GRO.

According to an embodiment of the disclosure, the operation of identifying the at least one first application-associated information corresponding to the first application may identify the at least one first application-associated information corresponding to the first application, based on execution of the first application, download of the first application, installation of the first application, a network connection request from the first application, and/or establishment of a PDU session corresponding to the first application.

According to an embodiment of the disclosure, the first application-associated information may include at least some of an application identifier (app ID), a DNN, a resource type, a 5QI value, a service priority, a delay, a traffic descriptor and/or route descriptor included in a URSP rule, an FQDN, a destination IP address, or group information.

According to an embodiment of the disclosure, the operation of identifying the flush time by inputting the information related to the communication environment of the electronic device 101 into the first AI model may identify the flush time by at least one first parameter configured as an input value of the first AI model into the first AI model as the information related to the communication environment of the electronic device 101.

According to an embodiment of the disclosure, the method of operating the electronic device 101 may include an operation of identifying at least one second application-associated information corresponding to a second application different from the first application. According to an embodiment of the disclosure, the method of operating the electronic device 101 may include an operation of, based on an AI model corresponding to the at least one second application-associated information, not existing by using the association information, identify the flush time for GRO by inputting the information related to the communication environment of the electronic device 101 into a default AI model or identify a default value as the flush time.

According to an embodiment of the disclosure, the information related to the communication environment may include at least one of information related to a channel environment, information related to a delay, or information related to a network environment. The information related to the channel environment may include at least one of an RSRP, an RSRQ, a BLER, a buffer status, a CQI, a DL TP, a UL TP, an RSSI, or an SINR. The information related to the network environment may include at least one of a destination IP address, a RTT, or an FQDN. The information related to the network environment may include at least one of an activated RAT, an MCS, an MSS, PDCP T-ordering, whether CA is activated, a number of activated CCs, a number of data streams, whether DC is activated, an operating band, an MIMO layer, or a bandwidth.

The operation of performing of the GRO operation, based on the identified flush time for GRO, may perform the GRO operation, based on a probability corresponding to the identified flush time for GRO, being higher than or equal to a threshold probability.

According to an embodiment of the disclosure, the operation of performing of the GRO operation, based on the identified flush time for GRO, may include an operation of identifying the flush time for comparison by inputting the information related to the communication environment of the electronic device 101 into a classification type AI model for comparison. The operation of identifying the GRO operation, based on the identified flush time for GRO may include an operation of performing the GRO operation, based on the flush time for comparison and the identified flush time for GRO satisfying a similarity association condition.

According to an embodiment of the disclosure, the method of operating the electronic device 101 may further include an operation of performing reinforcement learning on at least some of the plurality of AI models, based on an input value into at least some of the plurality of AI models, an output value from at least some of the plurality of AI models, and a value related to a TP associated with at least some of the plurality of AI models.

According to an embodiment of the disclosure, the first AI model in the plurality of AI models may be reinforcement-learned based on a compensation reference of a value identified based on a first processing scheme as a value related to the TP, and a second AI model different from the first AI model in the plurality of AI models may be reinforcement-learned based on a value identified based on a second processing scheme different from the first processing scheme as a value related to the TP.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions and storing information associated with a plurality of applications and association information between a plurality of artificial intelligence (AI) models; and
at least one processor communicatively coupled to the memory,
wherein the instructions, when executed by the at least one processor individually or collectively, cause the electronic device to:
identify at least one first application-associated information corresponding to a first application,
identify a first AI model corresponding to the at least one first application-associated information from among the plurality of AI models by using the association information, each of the plurality of AI models being trained according to different compensation references for a training data set,
identify a flush time for generic receive offload (GRO) by inputting information related to a communication environment of the electronic device into the first AI model, and
perform a GRO operation for merging at least some of packets provided by a lower layer, based on the identified flush time for GRO.

2. The electronic device of claim 1, wherein the instructions, when executed by the at least one processor individually or collectively, further cause the electronic device to, as at least a portion of the identifying of the at least one first application-associated information corresponding to the first application:
identify the at least one first application-associated information corresponding to the first application, based on execution of the first application, download of the first application, installation of the first application, a network connection request from the first application, and/or establishment of a protocol data unit (PDU) session corresponding to the first application.

3. The electronic device of claim 1, wherein the first application-associated information comprises at least some of an application identifier (app ID), a deep neural network (DNN), a resource type, a 5QI value, a service priority, a delay, a traffic descriptor and/or route descriptor included in a user equipment (UE) route selection policy (URSP) rule, a fully qualified domain name (FQDN), a destination Internet protocol (IP) address, or group information.

4. The electronic device of claim 1, wherein the instructions, when executed by the at least one processor individually or collectively, further cause the electronic device to, as at least a portion of the identifying of the flush time by inputting the information related to the communication environment of the electronic device into the first AI model:
identify the flush time by inputting, as the information related to the communication environment of the electronic device, at least one first parameter configured as an input value of the first AI model into the first AI model.

5. The electronic device of claim 1, wherein the instructions, when executed by the at least one processor individually or collectively, further cause the electronic device to:
identify at least one second application-associated information corresponding to a second application different from the first application,
based on no AI model corresponding to the at least one second application-associated information existing, by using the association information, and
identify the flush time for GRO by inputting the information related to the communication environment of the electronic device into a default AI model or identify a default value as the flush time.

6. The electronic device of claim 1,
wherein the information related to the communication environment comprises at least one of information related to a channel environment, information related to a delay, or information related to a network environment,
wherein the information related to the channel environment comprises at least one of a reference signal received power (RSRP), a reference signal received quality (RSRQ), a block error rate (BLER), a buffer status, a channel quality index (CQI), a downlink throughput (DL TP), a uplink throughput (UL TP), a received signal strength indicator (RSSI), or a signal to interference-plus-noise ratio (SINR),
wherein the information related to the delay comprises at least one of a destination IP address, a round trip time (RTT), or an FQDN, and
wherein the information related to the network environment comprises at least one of an activated radio access technology (RAT), a modulation and coding scheme (MCS), a mobile satellite services (MSS), packet data convergence protocol (PDCP) T-ordering, whether carrier aggregation (CA) is activated, a number of activated carrier components (CCs), a number of data streams, whether dual connectivity (DC) is activated, an operating band, a multiple-input and multiple-output (MIMO) layer, or a bandwidth.

7. The electronic device of claim 1, wherein the instructions, when executed by the at least one processor individually or collectively, further cause the electronic device to, as at least a portion of the performing of the GRO operation, based on the identified flush time for GRO:
perform the GRO operation, based on a probability corresponding to the identified flush time for GRO being higher than or equal to a threshold probability.

8. The electronic device of claim 1, wherein the instructions, when executed by the at least one processor individually or collectively, further cause the electronic device to, as at least a port of the performing of the GRO operation, based on the identified flush time for GRO:
identify a flush time for comparison by inputting the information related to the communication environment of the electronic device into a classification type AI model for comparision; and
perform the GRO operation, based on the flush time for comparison and the identified flush time for GRO satisfying a similarity association condition.

9. The electronic device of claim 1, wherein the instructions, when executed by the at least one processor individually or collectively, further cause the electronic device to:
perform reinforcement learning on at least some of the plurality of AI models, based on an input value into at least some of the plurality of AI models, an output value from at least some of the plurality of AI models, and a value related to a throughput (TP) associated with at least some of the plurality of AI models.

10. The electronic device of claim 9,
wherein the first AI model among the plurality of AI models is reinforcement-learned using, as a compensation reference, a value identified based on a first processing scheme as the value related to the TP, and
wherein a second AI model different from the first AI model among the plurality of AI models is reinforcement-learned using, as a compensation reference, a value identified based on a second processing scheme different from the first processing scheme as the value related to the TP.

11. A method of operating an electronic device, the method comprising:
identifying at least one first application-associated information corresponding to a first application;
identifying a first artificial intelligence (AI) model corresponding to the at least one first application-associated information among a plurality of AI models by using information associated with a plurality of applications and association information between the plurality of AI models, each of the plurality of AI models being trained according to different compensation references for a training data set;
identifying a flush time for generic receive offload (GRO) by inputting information related to a communication environment of the electronic device into the first AI model; and
performing a GRO operation for merging at least some of packets provided by a lower layer, based on the identified flush time for GRO.

12. The method of claim 11, wherein the identifying of the at least one first application-associated information corresponding to the first application comprises:
identifying the at least one first application-associated information corresponding to the first application, based on execution of the first application, download of the first application, installation of the first application, a network connection request from the first application, and/or establishment of a protocol data unit (PDU) session corresponding to the first application.

13. The method of claim 11, wherein the first application-associated information comprises at least some of an application identifier (app ID), a deep neural network (DNN), a resource type, a 5QI value, a service priority, a delay, a traffic descriptor and/or route descriptor included in a user equipment (UE) route selection policy (URSP) rule, a fully qualified domain name (FQDN), a destination Internet protocol (IP) address, or group information.

14. The method of claim 11, wherein the identifying of the flush time by inputting the information related to the communication environment of the electronic device into the first AI model comprises:
identifying the flush time by inputting, as the information related to the communication environment of the electronic device, at least one first parameter configured as an input value of the first AI model into the first AI model.

15. The method of claim 11, further comprising:
identifying at least one second application-associated information corresponding to a second application different from the first application;
based on no AI model corresponding to the at least one second application-associated information existing, by using the association information; and
identifying the flush time for GRO by inputting the information related to the communication environment of the electronic device into a default AI model or identifying a default value as the flush time.

16. The method of claim 11,
wherein the information related to the communication environment comprises at least one of information related to a channel environment, information related to a delay, or information related to a network environment,
wherein the information related to the channel environment comprises at least one of a reference signal received power (RSRP), a reference signal received quality (RSRQ), a block error rate (BLER), a buffer status, a channel quality index (CQI), a downlink throughput (DL TP), a uplink throughput (UL TP), a received signal strength indicator (RSSI), or a signal to interference-plus-noise ratio (SINR),
wherein the information related to the delay comprises at least one of a destination IP address, a round trip time (RTT), or an FQDN, and
wherein the information related to the network environment comprises at least one of an activated radio access technology (RAT), a modulation and coding scheme (MCS), a mobile satellite services (MSS), packet data convergence protocol (PDCP) T- ordering, whether carrier aggregation (CA) is activated, a number of activated carrier components (CCs), a number of data streams, whether dual connectivity (DC) is activated, an operating band, a multiple-input and multiple-output (MIMO) layer, or a bandwidth.

17. The method of claim 11, further comprising:
performing the GRO operation, based on a probability corresponding to the identified flush time for GRO being higher than or equal to a threshold probability.

18. The method of claim 11, further comprising:
identifying a flush time for comparison by inputting the information related to the communication environment of the electronic device into a classification type AI model for comparision; and
performing the GRO operation, based on the flush time for comparison and the identified flush time for GRO satisfying a similarity association condition.

19. One or more non-transitory computer-readable storage media storing one or more computer programs including computer-executable instructions that, when executed by at least one processor of an electronic device individually or collectively, cause the electronic device to perform operations, the operations comprising:
identifying at least one first application-associated information corresponding to a first application;
identifying a first artificial intelligence (AI) model corresponding to the at least one first application-associated information among a plurality of AI models by using information associated with a plurality of applications and association information between the plurality of AI models, each of the plurality of AI models being trained according to different compensation references for a training data set;
identifying a flush time for generic receive offload (GRO) by inputting information related to a communication environment of the electronic device into the first AI model; and
performing a GRO operation for merging at least some of packets provided by a lower layer, based on the identified flush time for GRO.

20. The one or more non-transitory computer-readable storage media of claim 19, the operations further comprising:
identifying the at least one first application-associated information corresponding to the first application, based on execution of the first application, download of the first application, installation of the first application, a network connection request from the first application, and/or establishment of a protocol data unit (PDU) session corresponding to the first application.
